(19) United States
(12) Patent Application Publication
(10) Pub. No.: US 2013/0132023 A1
(43) Pub. Date: May 23, 2013

(54) STRUCTURE FOR CHARACTERIZING THROUGH-SILICON VIAS AND METHODS THEREOF

(71) Applicant: Azeez J. Bhavnagarwala, Newtown, CT (US)

(72) Inventor: Azeez J. Bhavnagarwala, Newtown, CT (US)

(73) Assignee: ADVANCED MICRO DEVICES, INC., Sunnyvale, CA (US)

(21) Appl. No.: 13/299,036

(22) Filed: Nov. 17, 2011

(51) Int. Cl. G06F 19/00

(52) U.S. Cl. 702/118

(57) ABSTRACT

An integrated circuit device can include a number of test structures, whereby each test structure includes a TSV and a plurality of devices-under-test (DUTs). Each of the DUTs in a test structure has a different positional relationship, such as proximity or orientation, to the TSV. A test system can measure selected parameters such as transistor threshold voltage, leakage current, or other parameters, for each of the DUTs in the test structure. The measurements for different test structures can be combined to characterize nominal values of the measured parameter and its statistical distribution. This information provides an indication of how the measured parameter varies according to the positional relationship of a TSV to a DUT.

### BACKGROUND

1. Field of the Disclosure

The present disclosure generally relates to integrated circuit devices and more particularly to characterizing integrated circuit devices.

2. Description of the Related Art

Characterizing the physical properties and behavior of a device-under-test can be useful for designing an integrated circuit device. In particular, characterizing the device-under-test can improve the accuracy of integrated circuit design models, and can provide information that allows a designer to refine a device design, thereby improving device performance. For example, characterizing a device-under-test can provide a basis for modeling how different component structures interact, and the impact of the interaction on component behavior. The modeling can provide for alterations in integrated circuit device design and layout, thereby improving performance and reliability.

### BRIEF DESCRIPTION OF THE DRAWINGS

The present disclosure may be better understood, and its numerous features and advantages made apparent to those skilled in the art by referencing the accompanying drawings.

FIG. 1 is block diagram illustrating a test structure in accordance with one embodiment of the present disclosure.

FIG. 2 is a graphical diagram illustrating parameter measurements for the test structure of FIG. 1 in accordance with one embodiment of the present disclosure.

FIG. 3 is a block diagram of an integrated circuit device incorporating the test structure of FIG. 1 in accordance with one embodiment of the present disclosure.

FIG. 4 is a block diagram of an integrated circuit testing system in accordance with one embodiment of the present disclosure.

FIG. 5 is a flow diagram of forming an integrated circuit device using the integrated circuit testing system of FIG. 4 in accordance with one embodiment of the present disclosure.

The use of the same reference symbols in different drawings indicates similar or identical items.

### DETAILED DESCRIPTION

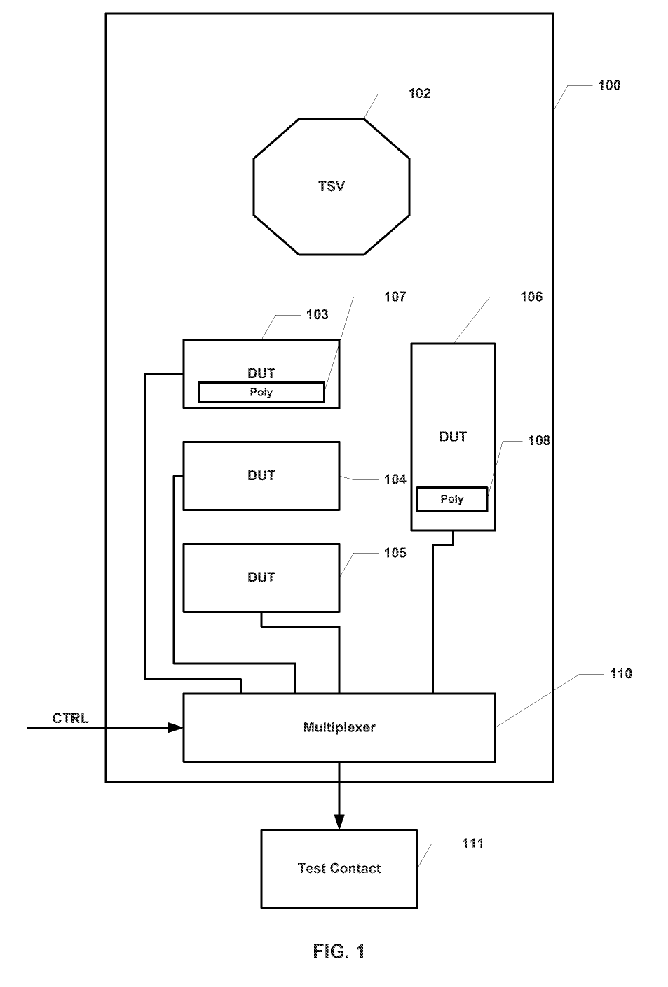

FIGS. 1-5 illustrate techniques for characterizing the impact of a through-silicon via (TSV) on the behavior of a set of integrated circuit devices. In particular, an integrated circuit device can include a number of test structures, whereby each test structure includes a TSV and a plurality of devices-under-test (DUTs). Each of the DUTs in a test structure has a different positional relationship, such as proximity or orientation, to the TSV. A test system can measure selected parameters such as transistor threshold voltage, leakage current, and the like, for each of the DUTs in the test structure. The measurements for different test structures can be combined to characterize nominal values of the measured parameter and its statistical distribution. This information provides an indication of how the measured parameter varies according to the positional relationship of a TSV to a DUT, and can be employed to adjust layout rules and other design specifications for an integrated circuit device.

FIG. 1 illustrates a block diagram of a test structure 100 in accordance with embodiment of the present disclosure. The test structure 100 is formed at an integrated circuit device. In an embodiment, the integrated circuit device is specifically designed and formed for test and characterization purposes. In another embodiment, the test structure 100 can be formed at an integrated circuit device designed for general use.

The test structure 100 includes a TSV 102, DUTs 103-106, and a multiplexer 110. Each of the DUTs 103-106 are connected to the multiplexer 110. The multiplexer 110 also includes an input to receive a control signal and an output connected to a test contact 111. The TSV 102 is an electrical connection that passes through a silicon wafer or die. Each of the DUTs 103-106 is a passive circuit element, an active circuit element, a logic module, memory structure, and the like, or combination thereof. Accordingly, each of the DUTs 103-106 can be a resistor, capacitor, inductor, transistor, logic gate, memory cell, and the like or any combination thereof. Each of the DUTs 103-106 has the same type of structure (e.g. all of the DUTs 103-106 is an implementation of the same element, logic module, and the like).

The multiplexer 110 facilitates testing of the DUTs 103-106. In particular, in response to a test stimulus, each of the DUTs 103-106 is configured to provide, via its corresponding connection to the multiplexer 110, a signal indicating the value of a parameter associated with the DUT, such as threshold voltage, leakage current, and saturation drain current. The test stimulus is typically applied by a test system that controls operation of the integrated circuit associated with the test structure 100. The test system further supplies a control signal to the multiplexer 110 that selectively applies one of the input signals of the multiplexer 110 at its output. The output signal can be accessed via the test contact 111. In particular, the test contact 111 is an electrical contact, such as input/output pad, connected to a test system. The test system is configured to record the parameter value indicated by the signal together with an indication of the device associated with the parameter value. By sequencing the control signal in an appropriate manner, the test system can record parameter values for each of the DUTs 103-106.

Each of the DUTs 103-106 has a different positional relationship to the TSV 102. For example, each of the DUTs 103-105 has a different proximity to the TSV 102. The DUT 103 can have a different orientation with respect to the TSV 102 than does the DUT 106. Thus, in the illustrated example, DUT 103 has a polysilicon (poly) layer 107 that is longitudinal with respect to the DUT 103, while DUT 106 includes a poly layer 108 that is transverse with respect to the DUT 106. Thus, each DUT can have a polysilicon layer oriented in a transverse or longitudinal relationship with respect to the TSV 102. In other embodiments, different layers of each DUT can have a different orientation with respect to the TSV 102.

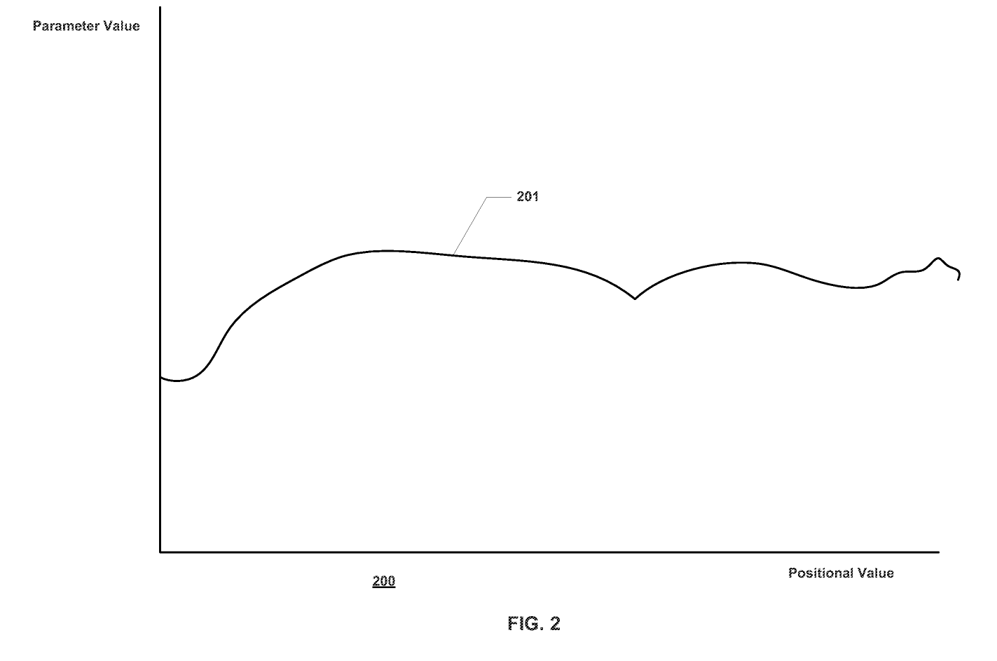

Because each of the DUTs 103-106 has a different positional relationship to the TSV 102, the parameter values measured by the test system will indicate the effect of the TSV 102 on the measured parameter as the effect varies based on the positional relationship. This can be better understood with reference to FIG. 2, which illustrates a diagram 200 showing a curve 201. The x-axis of the diagram 200 represents the positional value (such as proximity, orientation, and the like) of a DUT relative to the TSV 102, and the y-axis represents a parameter value (such as threshold voltage, leakage current, and the like). Accordingly, each point of the curve 201 represents the measured parameter value for the DUT at the corresponding position. The curve 201 therefore indicates how the impact of the TSV 102 on the measured parameter varies based on the position of the DUT.

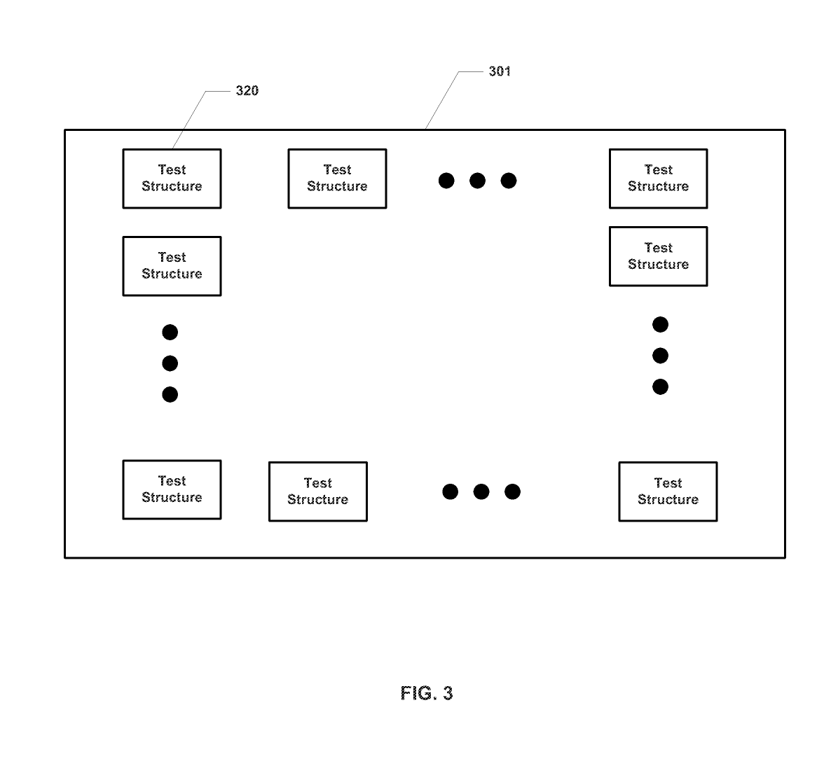

FIG. 3 illustrates an integrated circuit device 301 in accordance with one embodiment of the present disclosure. The integrated circuit device 301 includes a set of test structures, such as test structure 320, where each test structure in the set is similar to the test structure 100 of FIG. 1. Each of the test structures in the illustrated set therefore has a set of DUTs at common relative positions to its corresponding DUT. Accordingly, a test system can measure selected parameters for the DUTs at each of the test structures, and then combine the measured parameters to characterize nominal values of the measured parameter as well as its statistical distribution. For example, the test system can determine the average measured parameter value at each positional relationship over the test structures, as well as the standard deviation in the parameter values.

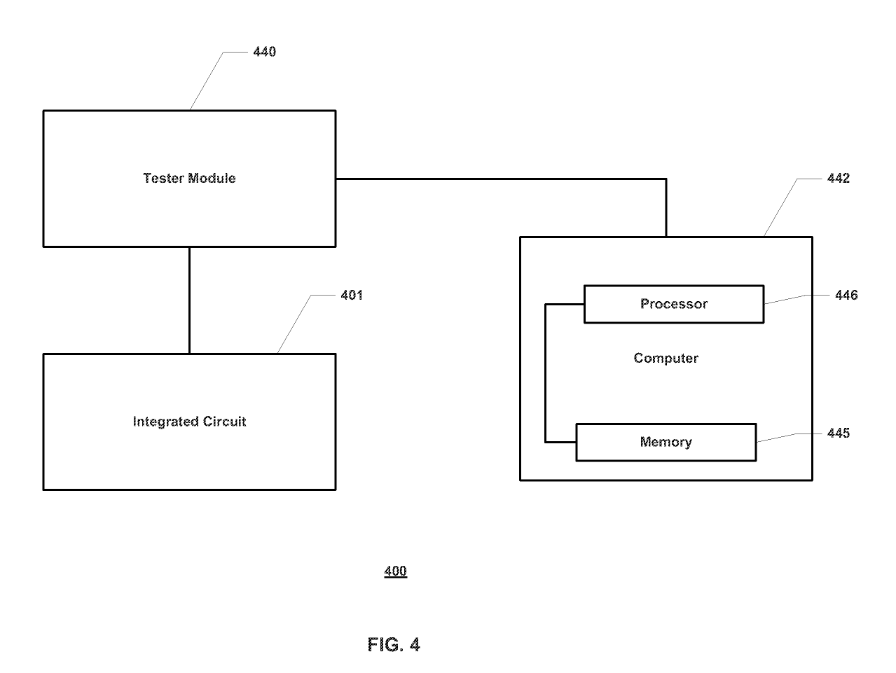

FIG. 4 illustrates a test system 400 in accordance with one embodiment of the present disclosure. The test system 400 includes an integrated circuit 401, a tester module 440, and a computer device 442 having a memory 445. The tester module 440 is connected to the integrated circuit 401 and the computer 442. The integrated circuit 401 is formed to have a plurality of test structures similar to the integrated circuit 301 of FIG. 3.

The computer device 442 includes a processor 446 and a memory 445. The processor 446 is configured to be manipulated by sets of instructions in order to execute tasks indicated by the instructions. The processor 446 can be manipulated by the sets of instructions to carry out any of the methods described herein. The memory 445 is a computer readable medium configured to store both data and the sets of instructions to manipulate the processor 446. The memory 445 can be volatile memory or non-volatile memory, or any combination thereof Accordingly the memory 445 can be random access memory (RAM), flash memory, a hard disk drive, and the like, or any combination thereof

The computer 442 is configured to provide a user interface for control of the tester module 440. Accordingly, the computer device 442 provides a user interface to allow user selection of the criteria for a particular test, such as the parameters to be measured, the test stimulus for the test, which DUTs are to be tested, which test structures are to be tested, and the like. The tester module 440 is a module configured to receive instructions from the computer device 442 indicating the selected criteria, to provide the indicated test stimulus to the integrated circuit 401, to configure the integrated circuit 401 to measure the selected parameter, to receive the signals indicating the measured parameters, and to provide information indicating the measured parameters to the computer device 442. The computer device can store the measured parameter values at the memory 445 for subsequent analysis, including calculation of nominal values for the measured parameter, statistical distribution of the measured parameter, and the like.

In an embodiment, the computer device 442 is part of a design system, whereby the values for the measured parameter can be used to adjust an integrated circuit design. For example, the measured parameter values can indicate that a TSV has an undesirable impact on the behavior of a particular DUT when the TSV is within a certain proximity (referred to for purposes of discussion as the Impact Distance) of the DUT. Accordingly, the design system can automatically, or in response to user input, alter a layout design rule for an integrated circuit device design so that devices or structures similar to the DUT are not located, or are less likely to be located, within the Impact Distance.

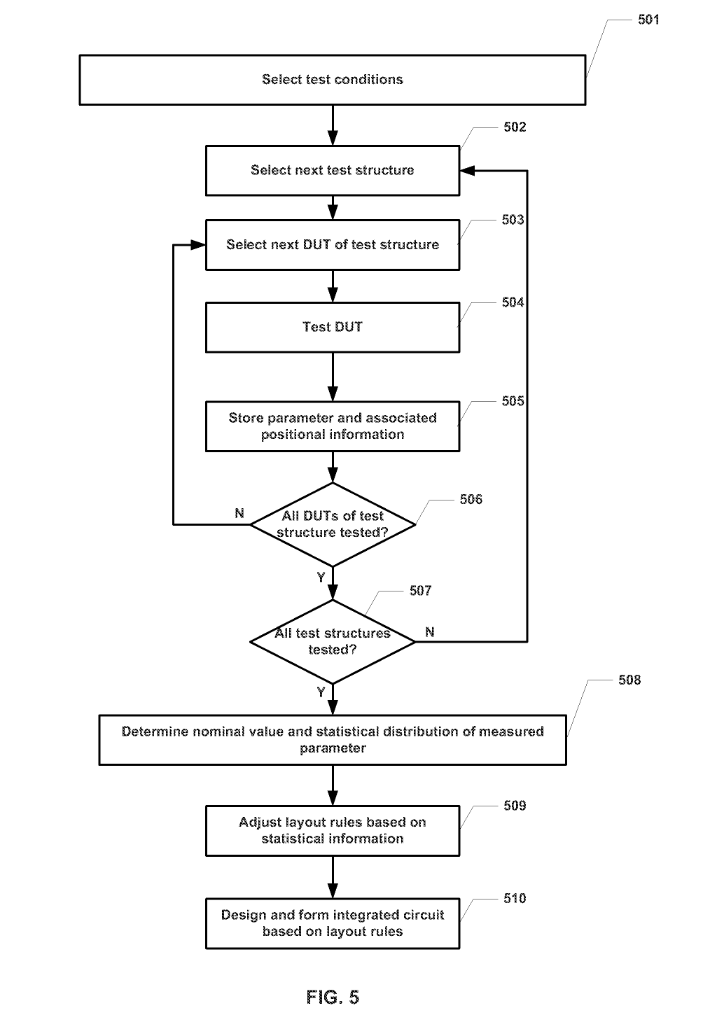

Operation of the test system can be better understood with reference to FIG. 5, which illustrates a flow diagram of a method of forming an integrated circuit device using the testing system 400 in accordance with one embodiment of the present disclosure. At block 501, the computer 442, in response to a user input or other stimulus, selects a set of test conditions. The test conditions can include a parameter to be measured, the conditions under which the parameter is to be measured, and the like. In an embodiment, the test conditions can also include a selection of individual test structures, or individual DUTs, to be tested. Based on the selected test conditions, the computer 442 sends control signaling to the test module 440 to apply the test conditions to the integrated circuit 401.

At block 502, the tester module 440 selects the next test structure, as indicated by the test conditions, to be tested. At block 503 the tester module 440 selects the next DUT of the test structure to be tested. At block 504, the tester module 440 tests the selected DUT by applying the test conditions to the selected DUT and measuring the parameter indicated by the test conditions. At block 505 the tester module sends the measured parameter and the positional information for the selected DUT to the computer 442. In response, the computer 442 stores the measured parameter and associated positional information at the memory 445.

At block 506, the tester module 440 determines whether all DUTs of the currently-selected test structure as indicated by the test conditions have been tested. If not, the method flow returns to block 503 and the tester module 440 selects the next DUT of the test structure for testing. If all of the DUTs of the test structure have been tested, the method flow proceeds to block 507, and the tester module 440 determines whether all test structures of the integrated circuit 401, as indicated by the test conditions, have been tested. If not, the method flow returns to block 502 and the tester module 440 selects the next test structure of the integrated circuit 401. If all of the test structures have been tested, the method flow proceeds to block 508 and the computer 442 determines a nominal value and a statistical distribution for the measured parameter for each positional value. At block 509, the computer 442 adjusts layout rules for an integrated circuit based on the nominal value and the statistical distribution. For example, a layout rule can prohibit a specified circuit element from being located within a specified distance of a TSV. Based on the nominal value and statistical distribution, the computer 442 can adjust the specified distance of the layout rule, so that the specified circuit element can be located closer, or must be located further away from, a TSV. At block 510, the computer 442 and other modules of the testing system 400 (not shown) designs and forms an integrate circuit based on the layout rules.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method implemented at a data processing device, comprising:
determining a first set of parameter measurements for a first test structure comprising a first plurality of devices-under-test and a first through-silicon via (TSV), each of the first plurality of devices-under-test having a different positional relationship to the first TSV; and
storing the first set of parameter measurements.

2. The method of claim 1, wherein one of the first plurality of devices-under-test has a different proximity to the first TSV than another of the first plurality of devices-under-test.

3. The method of claim 1, wherein one of the first plurality of devices-under-test has a different orientation with respect to the first TSV than another of the first plurality of devices under test.

4. The method of claim 3, wherein a first device of the first plurality of devices-under-test has a polysilicon layer having a longitudinal relationship with respect to the first TSV.

5. The method of claim 4, wherein a second device of the first plurality of devices-under-test has a polysilicon layer having a transverse orientation with respect to the first TSV.

6. The method of claim 1, wherein the first test structure is located at an integrated circuit device, and further comprising:
determining a second set of parameter measurements for a second test structure located at the integrated circuit device, the second test structure comprising a second plurality of devices-under-test and a second through-silicon via (TSV), each of the second plurality of devices-under-test having a different positional relationship to the second TSV; and
storing the second set of parameter measurements.

7. The method of claim 1, further comprising:
characterizing an effect of an operation of the TSV on proximate circuit elements in an integrated circuit device based on the first set of parameters measurements.

8. The method of claim 1, further comprising determining an average value based on the first set of parameter measurements, and storing the average value.

9. The method of claim 1, further comprising determining a statistical distribution based on the first set of parameter measurements, and storing the statistical distribution.

10. The method of claim 1, further comprising setting a layout rule for an integrated circuit device based on the first set of parameter measurements.

11. The method of claim 10, further comprising forming the integrated circuit device based on the layout rule.

12. An integrated circuit device, comprising:
a first test structure, comprising:
a first plurality of devices-under-test; and
a first through-silicon-via (TSV), each of the first plurality of devices-under-test having a different positional relationship to the first TSV; and
a first test contact to provide parameter measurements in response to a test stimulus.

13. The device of claim 12, wherein one of the first plurality of devices-under-test has a different proximity to the first TSV than another of the first plurality of devices-under-test.

14. The device of claim 12, wherein one of the first plurality of devices-under-test has a different orientation with respect to the first TSV than another of the first plurality of devices under test.

15. The device of claim 14, wherein a first device of the first plurality of devices-under-test has a polysilicon layer having a longitudinal orientation with respect to the first TSV.

16. The device of claim 15, wherein a second device of the first plurality of devices-under-test has a polysilicon layer having a transverse orientation with respect to the first TSV.

17. The device of claim 12, further comprising:
a second test structure, comprising:
a second plurality of devices-under-test; and
a second through-silicon-via (TSV), each of the second plurality of devices-under-test having a different positional relationship to the second TSV.

18. A computer readable medium embodying a set of instructions to manipulate a processor to perform a method comprising:
applying a test stimulus to an integrated circuit comprising a test structure including a plurality of devices-under-test (DUTs) and a through-silicon-via (TSV), a first of the plurality of DUTs having a different positional relationship to the TSV than another of the plurality of DUTs;
determining a set of parameter measurements associated with the plurality of DUTs in response to the test stimulus; and
storing the set of parameter measurements.

19. The computer readable medium of claim 18, wherein the one of the plurality of DUTs has a different proximity to the TSV than the another of the plurality of DUTs.

20. The computer readable medium of claim 18, wherein the one of the plurality of devices-under-test has a different orientation with respect to the TSV than the another of the first plurality of devices under test.
